(19) United States
(12) Patent Application Publication
(10) Pub. No.: US 2010/0048074 A1
(43) Pub. Date: Feb. 25, 2010

(54) High abrasion resistance tape, particularly for bandaging cable harnesses in cars

(75) Inventors: Andreas WAHLERS-SHCMIDLIN, Guderhandviertel (DE); Patrik KOPF, Hamburg (DE); Ronald PFAFF, Hamburg (DE)

Correspondence Address: Briscoe, Kurt G.;Norris McLaughlin & Marcus, PA, 875 Third Avenue, 8th Floor, New York, NY, 10022, US

(73) Assignee: tesa SE, Hamburg (DE)

(21) Appl. No.: 12/543,707

(22) Filed: Aug. 19, 2009

(30) Foreign Application Priority Data
Aug. 21, 2008 (DE) 10 2008 038 597.2
Nov. 19, 2008 (DE) 10 2008 058 226.3

(51) Int. Cl. B32B 5/02; B32B 37/12

(52) U.S. Cl. 442/60; 156/215; 442/189

(57) ABSTRACT

Highly abrasion-resistant tape, preferably for sheathing elongate material such as more particularly leads or cable looms, having a woven fabric backing, characterized in that the woven fabric is composed of a plastics material, the yarns used to form the fabric have a linear density of 280 to 1100 dtex, and each yarn is constructed from at least 90 single filaments.

The invention relates to a highly abrasion-resistance tape, preferably for sheathing elongate material such as more particularly leads or cable looms, comprising a backing applied preferably to at least one side of which there is a pressure-sensitive adhesive coating. The invention further relates to the use of the tape and also to a cable harness wrapped with the tape of the invention.

Many sectors of industry wrap bundles composed of a multiplicity of electrical leads, before installation or in the ready-installed state, in order by such bandaging to reduce the space taken up by the bundle of leads and also, in addition, to obtain protective functions. With film-backed adhesive tapes, a certain level of protection from ingress of fluid is achieved; with airy and bulky adhesive tapes based on thick nonwoven or foam backing materials, insulating properties are obtained; and, when stable, abrasion-resistant backing materials are used, a protective function against scuffing and rubbing is produced.

The abrasion resistance is a measure of the scuff resistance of adhesive tapes. An established method of determining the abrasion resistance of protective systems in the vehicle's electrics is the International Standard ISO 6722, Section 9.3 “Scrape abrasion test” (April 2002 edition). Based on the ISO 6722 standard, the scrape abrasion resistance of adhesive tapes is tested in accordance with LV 312. The test specimen, with a length of approximately 10 cm, is adhered longitudinally in a single ply to a steel mandrel 5 or 10 mm thick. The abrading tool used is a steel wire of 0.45 mm diameter which rubs the test specimen centrally under a weight loading of 7 N. The numerical measure determined for the abrasion properties is the number of back-and-forth strokes taken to destroy the test specimen. In the case of very high abrasion resistances it has been found appropriate to measure the adhesive tape on a 5 mm diameter metal mandrel as well. This allows simulation of abrasion resistance with respect to relatively sharp objects such as a metal edge, for example.

The result of the test is termed the abrasion class of the test specimen, with the mandrel diameter and weight loading being specified. Adhesive tapes are classified into classes A to F as per the table.

TABLE
Division into abrasion classes under LV312 (February 2008)

| Abrasion class | Requirement | |
|---|---|---|
| A no abrasion protection | <100 | strokes |
| B low abrasion protection | 100-499 | strokes |
| C moderate abrasion protection | 500-999 | strokes |
| D high abrasion protection | 1000-4999 | strokes |
| E very high abrasion protection | 5000-14999 | strokes |
| F extremely high abrasion protection | ≧15000 | strokes |

The noise suppression effect is a measure of the noise-reducing action of adhesive tapes.

The physical measurement of the noise suppression effect is made in accordance with the method described in detail in DE 100 39 982 A1. This is a measurement methodology which is established in the motor vehicle industry, as specified for example in the BMW Standard GS 95008-3 (May 2000 edition).

Detailed below in conjunction with FIGS. 1 and 2 is the measurement method of the BMW Standard GS 95008-3 from May 2000.

With this measurement method, a defined steel rod (1) with a diameter of 8 mm is wrapped with the test specimen (2) —or adhesive tape—in such a way as to produce lever lengths of 220 mm and 150 mm. The wrapped steel rod (1) is dropped onto an aluminium sheet (5), by the drop height and with a weight of around 16 g, until the stop (3) is reached. The aluminium sheet (5), which in the undeformed state measures 350×190×0.3 [mm], is arranged in the form of a half-barrel beneath the test specimen (2), producing a span of 290 mm.

The overall sound outcome is detected and recorded by means of a microphone (4) disposed over the test arrangement, in a frequency range of, for example, 20 to 12 500 Hz, using a commercial noisemeter, of type 2226 from Bruel & Kjaer, for example. Particularly relevant for the human ear are frequencies in the range from 2000 to 5000 Hz.

The suppression is reported as the difference between the blank value with unwrapped steel rod and the respective measurement value, in dB(A).

The adhesive tapes, in accordance with the Automotive Testing Directive LV 312 (February 2008 edition), are also classified into noise suppression classes (class A, low noise suppression, to class E, very high noise suppression; measurement is made in dB(A)).

The table below offers an overview of the above-described classification:

| | | dB(A) |
|---|---|---|
| | | suppression |
| Class | Classification | requirement |
| A | none/low | 0 to <2 |
| B | low | >2 to <5 |
| C | moderate | >5 to <10 |
| D | high | >10 to <15 |
| E | very high | >15 |

In order to protect vehicle leads from mechanical effects and rubbing on sharp-edged bodywork components, the systems nowadays used also include braided hoses made from polyamide, polyester and polyethylene engineering materials. Effective protection from abrasion is achieved in such products through the use of monofilament yarns. A disadvantage of such yarns is the particularly high stiffness, owing to the comparatively large diameter of each individual filament.

To allow the production of sufficiently flexible products for use in vehicle construction, therefore, it is necessary to choose an open braided construction, which allows the yarns to shift.

Owing to the open braiding, this kind of fabric cannot be used for coating with an adhesive in order to produce adhesive tapes, since in the coating operation the adhesive would run through the holes.

For flexible woven fabrics, which are typically the backing material for tapes, multifilament yarns are employed. The high flexibility of the fabrics is achieved through the use of yarns having a large number of single filaments.

However, it is not possible to produce a high level of abrasion protection through the use of a large number of single filaments.

DE 20 2006 015 701 U discloses a cable wrap tape, intended more particularly for the engine compartment of a car, having a tape-like backing which is composed of woven fabric and which is provided on at least one side with a self-adhesive layer composed of a pressure-sensitive adhesive.

The woven fabric of the backing is composed of a yarn formed from an engineering-grade polyamide material, with a linear density of at least 280 dtex, the yarn being formed from 24 to 80 filaments, and the cable wrap tape meeting LV 312 abrasion class E both on a 5 mm diameter mandrel and on a 10 mm diameter mandrel.

It is an object of the invention to obtain a marked improvement over the prior art and to provide a tape which affords the possibility of bandaging individual leads to form cable looms with high protection against mechanical damage due to scuffing and rubbing on sharp edges, burrs or weld spots.

This object is achieved by means of a tape as described in greater detail hereinbelow. Additional embraced by the concept of the invention are the use of the tape of the invention, and also a cable harness wrapped with the tape.

The invention accordingly provides a highly abrasion-resistant tape, preferably for sheathing elongate material such as, more particularly, leads or cable looms, having a woven fabric backing, where the fabric is composed of a plastics material, the yarns used to form the fabric have a linear density of 280 to 1100 dtex, and each yarn is constructed from at least 90 single filaments.

### BRIEF DESCRIPTION OF THE DRAWINGS

The invention will be described in greater detail with reference to the drawings, wherein:

FIG. 1 shows the construction of the measuring apparatus in side elevation,

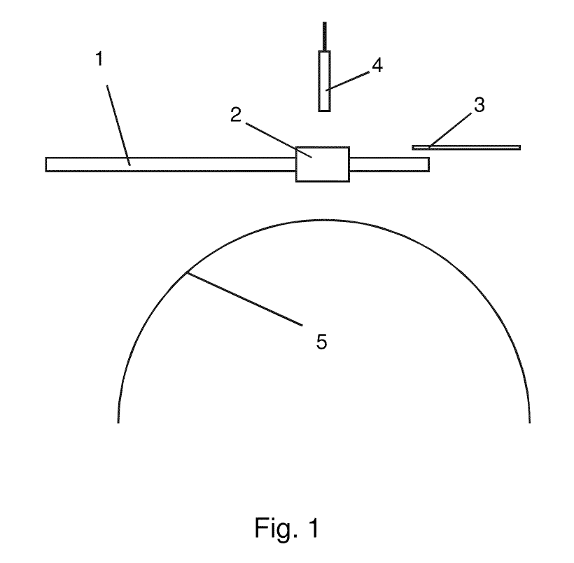

FIG. 2 shows the same construction in horizontal elevation,

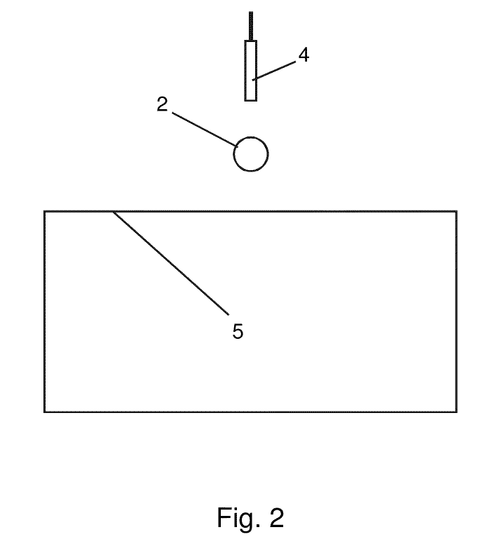

FIG. 3 shows a photograph of the tape of the invention in cross section,

FIG. 4 shows a section of a cable loom which is composed of a bundle of individual cables 7 and which is wrapped with the adhesive tape of the invention,

FIG. 5 shows a wrap composed of a jacket equipped with two adhesive tape sections,

FIG. 6 shows a cable loom which is wrapped,

FIG. 7 shows a jacket equipped with an adhesive tape section, with the adhesive facing outwards,

FIG. 8 shows a jacket equipped with an adhesive tape section, with the adhesive facing inwards,

FIG. 9 shows a second wrap, composed of a jacket equipped with two adhesive tape sections,

FIG. 10 shows the material wrapped with the wrap from FIG. 9,

FIG. 11 shows a further wrap, composed of a jacket equipped with two adhesive tape sections, with one adhesive tape section being double-sidedly adhesive, and

FIG. 12 shows two inventive tapes 60 and 70, equipped with an adhesive, laminated to one another with their adhesives offset.

On the basis of the outstanding configuration of the tape, the cable wrap tape attains LV312 abrasion class E on a 5 mm mandrel and a 10 mm mandrel, and, furthermore, even achieves LV312 abrasion class F on a 5 mm mandrel and a 10 mm mandrel, a feat of a kind that could not have been expected by the skilled person.

In accordance with one advantageous embodiment of the invention, the yarns used are constructed from 90 to 288 single filaments, preferably 100 to 150 single filaments, more preferably 130 to 145 single filaments.

With further preference the number of warp threads in the woven backing is in the 12 to 45 per cm range, preferably 15 to 25 per cm, and/or the number of weft threads in the woven backing is in the 10 to 35 per cm range, preferably 15 to 25 per cm.

In accordance with another advantageous embodiment of the invention, the woven backing has a basis weight of 130 to 300 g/m², preferably 180 to 220 g/m².

Finally, polymers used for the plastics material of the fabric are nylon 6, nylon 4,6, nylon 6,6, nylon 6,6 heat-stabilized, nylon 4,6, high-temperature polyamide, polyphenylene sulfides (PPS) or polyether ketones (PEEK), preferably nylon, more preferably nylon 6,6.

In accordance with one advantageous embodiment of the invention an adhesive coating is applied on at least one side to the backing.

The coatweight of the adhesive on the backing is advantageously in the range between 20 to 150 g/m².

With further preference the adhesive coating is a self-adhesive coating particularly based on rubber, acrylate or silicone.

Producing a self-adhesive tape from the backing can be done using any known adhesive systems. As well as natural or synthetic rubber-based adhesives it is possible to use silicone adhesives and also polyacrylate adhesives. On account of their particular suitability as an adhesive for wrapping tapes for automotive cable looms, in respect of absence of fogging and also of outstanding compatibility with both PVC and PVC-free core insulation, preference is given to solvent-free acrylate hotmelts, as described in DE 198 07 752 A1 and also in DE 100 11 788 A1 in more detail.

Appropriate coating technology includes known systems, with useful processes being those which allow unpressurized placement of high-viscosity adhesives: examples are the coating of hotmelt adhesives via nozzles or via transfer from an anti-adhesive carrier cloth or release liner onto the backing assembly.

A suitable adhesive is one based on acrylate hotmelt with a K value of at least 20, more particularly greater than 30 (measured respectively in 1% strength by weight solution in toluene, 25° C.), obtainable by concentrating a solution of such an adhesive to form a system which can be processed as a hotmelt.

This concentration may take place in appropriately equipped tanks or extruders; particularly in the case of concomitant degassing, a degassing extruder is preferred. One adhesive of this kind is set out in DE 43 13 008 C2. In an intermediate step, the solvent is removed entirely from these acrylate adhesives produced in this way. The K value in this case is determined in particular by analogy to DIN 53 726.

In addition, further volatile constituents are removed in this procedure. After coating from the melt, these adhesives have only small residual fractions of volatile constituents. Hence it is possible to adopt all of the monomers/formulas that are claimed in the patent recited above.

The solution of the adhesive may contain 5% to 80% by weight, more particularly 30% to 70% by weight, of solvent.

Preference is given to using commercial solvents, more particularly low-boiling hydrocarbons, ketones, alcohols and/or esters.

Further preference is given to using single-screw, twin-screw or multi-screw extruders with one or, more particularly, two or more degassing units.

The acrylate hotmelt-based adhesive may have had benzoin derivatives incorporated into it by polymerization, for example benzoin acrylate or benzoin methacrylate, acrylic or methacrylic esters. Benzoin derivatives of this kind are described in EP 0 578 151 A.

The acrylate hotmelt-based adhesive may be UV-crosslinked. Other modes of crosslinking are also possible, however, an example being electron beam crosslinking. In another preferred embodiment the self-adhesives used are copolymers of (meth)acrylic acid and the esters thereof with 1 to 25 C atoms, maleic, fumaric and/or itaconic acid and/or esters thereof, substituted (meth)acrylamides, maleic anhydride and other vinyl compounds, such as vinyl esters, more particularly vinyl acetate, vinyl alcohols and/or vinyl ethers.

The residual solvent content ought to be below 1% by weight.

One adhesive found to be particularly suitable is a low molecular mass acrylate hotmelt PSA of the kind carried under the name acResin UV or Acronal®, especially acResin 258UV, by BASF. This low-K-value adhesive acquires its application-compatible properties by virtue of a concluding, radiation-chemically initiated crosslinking.

The adhesive may be applied in the form of a stripe in the longitudinal direction of the adhesive tape, the width of the stripe being lower than that of the backing of the adhesive tape.

Depending on the particular utility, it is also possible for the backing material to be coated with two or more parallel strips of the adhesive.

The position of the stripe on the backing is freely selectable, preference being given to an arrangement directly at one of the edges of the backing.

On the adhesive coating of the backing there may be at least one stripe of a covering, extending in the longitudinal direction of the adhesive tape and covering between 20% and 80% of the adhesive coating.

In accordance with one preferred embodiment of the invention there is precisely one stripe of the covering present on the adhesive coating.

The position of the stripe on the adhesive coating is freely selectable, with preference being given to an arrangement directly at one of the longitudinal edges of the backing. In this way an adhesive stripe is produced which extends in the longitudinal direction of the adhesive tape and finishes at the other long edge of the backing.

Where the adhesive tape is used to wrap a cable loom, by the adhesive tape being led in a helicoidal movement around the cable loom, the sheathing of the cable loom may be accomplished by bonding the adhesive of the adhesive tape only to the adhesive tape itself, with the material not coming into contact with any adhesive.

The cable loom wrapped in this way has a very high flexibility as a result of the absence of the fixing of the cable by any adhesive. Consequently its flexibility on installation—particularly in narrow passages or sharp bends—is significantly increased.

If a certain degree of fixing of the adhesive tape on the material is desired, then wrapping can be accomplished by bonding part of the adhesive stripe to the adhesive tape itself, and another part to the material.

In accordance with another advantageous embodiment, the stripe is applied centrally on the adhesive coating, thereby producing two adhesive stripes extending on the long edges of the backing in the longitudinal direction of the adhesive tape.

For the secure and economic application of the adhesive tape in said helicoidal movement around the cable loom, and to counter the slipping of the resultant protective sheathing, the two adhesive stripes each present on the long edges of the adhesive tape are advantageous, especially if one, which is usually narrower than the second stripe, serves as a fixing aid and the second, broader stripe serves as a fastener. In this way the adhesive tape is bonded to the cable in such a way that the cable loom is secured against slipping but is nevertheless of flexible design.

In addition there are embodiments in which more than one stripe of the covering is applied to the adhesive coating. Where reference is made only to one stripe, the skilled person reads this, conceptually, as accommodating the possibility that it is readily possible for two or more stripes to cover the adhesive coating at the same time.

The stripe preferably covers a total of between 50% and 80% of the adhesive coating. The degree of coverage is selected as a function of the application and of the diameter of the cable loom.

With particular preference there remain one or two adhesive stripes, whose total width accounts for 20% to 50% of the width of the backing.

Particularly if the adhesive coating is not a full-area coating but instead is, for example, in stripe form, the stated percentages relate to the width of the stripes of the jacket in relation to the width of the backing; or, in accordance with the invention, the stripe or stripes of the jacket have a width which accounts for between 20% and 80% of the width of the backing.

Suitable materials for the covering include the customary films in particular for cable bandaging applications, based on polyolefins (for example polyethylene films, polypropylene films, monoaxially or biaxially oriented polypropylene films, polyester films, PA films, and other films) or PVC, preferably those having plasticizer contents of between 20 and 60 phr.

The backing and/or the adhesive coating may additionally have been made flame retardant by means, for example, of a flame retardant composed of ammonium polyphosphate, magnesium hydroxide and/or aluminium hydroxide, or by means of a chlorinated paraffin, where appropriate in combination with antimony trioxide. The flame retardants may also be organic bromine compounds, where necessary with synergists such as antimony trioxide, although, with a view to the absence of halogen from the adhesive tape, preference is given to using red phosphorus compounds, organic phosphorus compounds, mineral compounds or intumescent compounds such as ammonium polyphosphate, alone or in conjunction with synergists.

In order to optimize the dispensing of the adhesive tape, in one preferred embodiment of the invention, there are weakening lines which extend over the entire width of the adhesive tape.

In order to allow particularly simple operation for the user, the weakening lines are aligned at right angles to the running direction of the adhesive tape and/or are disposed at regular intervals. The adhesive tape is therefore hand-tearable in transverse direction. A further improvement in the context of the use of the adhesive tape can be achieved if the adhesive tape is severed completely, at preferably regular intervals, and applied in the form of what are called “kiss-cut diecuts” to release paper. In this way the individual diecuts can be dispensed selectively through the use of a dispenser.

The weakening lines are preferably configured in the form of perforations. In this way it is possible to obtain edges between the individual sections that are highly lint-free, thus preventing unwanted fraying.

The weakening lines can be produced in a particularly advantageous way either discontinuously, using flat dies or cross-running perforating wheels, or continuously, using rotary systems such as spiked rollers or punch rollers, with or without the use of a counter-roller (Vulkollan roller) forming the counterwheel during cutting.

Further possibilities include cutting technologies which are controlled to operate intermittently, such as the use of lasers, ultrasound or high-pressure waterjets, for example. Where, in the case of laser cutting or ultrasound cutting, some of the energy is introduced into the material in the form of heat, it is possible to melt the material in the area of cutting, thereby very largely preventing disruptive fraying, and producing sharply contoured cut edges. Latter methods are also suitable for obtaining specific cut-edge geometries such as concave or convex cut edges, for example.

The height of the spikes or blades on the punch rollers is preferably 150% of the thickness of the adhesive tape.

The hole/bridge ratio in the case of perforation—that is, the ratio of the number of millimetres where the material holds together (“bridge”) to the number of millimetres over which it is severed—determines how easy the adhesive tape is to tear. Furthermore, this ratio also ultimately influences the extent to which the torn edge is lint-free.

The bridge width is preferably approximately 0.2 mm and the cut width between the bridges is preferably approximately 5 mm: in other words, bridges 0.2 mm wide alternate with incisions 5 mm long. The hole/bridge ratio, accordingly, is preferably 1:25.

With this weakening of the material it is possible to achieve a sufficiently low tearing force.

In accordance with one advantageous embodiment, and to find use as a bandaging tape, the ultimate tensile strength of the tape is more than 500 N/cm and/or the elongation at break is between 35% and 65%.

These values are measured in accordance with DIN EN ISO 13934-1.

The adhesive tape is used preferably for wrapping elongate material such as, more particularly, cable looms, the elongate material being sheathed in the axial direction by the adhesive tape, or the adhesive tape being led in a helicoidal spiral around the elongate material.

Surprisingly it is found that, by virtue of the woven fabric backing, the tape of the invention exhibits high abrasion resistance in tandem with flexibility. The high number of single filaments in the yarns, in conjunction with the nylon fabric preferably employed, produces a particularly conforming fabric with a smooth surface. Under frictional exposure from the outside, the fabric may appear to evade the friction-causing object, and the fabric acquires higher abrasion properties.

Particularly smooth and (circularly) round filaments, whose use is preferred, facilitate the evading of the abrading article still further.

This is also shown by the attached comparison, in which a braided hose has been set alongside a tape of the invention with a nylon fabric.

The customary commercial braided hoses are produced from monofilaments, have a coverage of 60% to 90%, and use polyesters and polyamide as the base polymer material. Where polyamide is used, high abrasion resistance and shear resistance are described. The ready displaceability and deformability of the braiding is necessary for the transit of the electrical cables. As a result of the solid monofilaments, abrasion protection is achieved, but gives the braided hoses a high flexural rigidity.

A fabric of the invention, produced from multifilament nylon yarns, exhibits a virtually complete coverage as a result of the plain-weave construction, which allows coating of adhesive. The low flexural rigidity allows it to be used as an adhesive tape and ensures a flexible cable loom in the end application. The abrasion properties achieved by the nylon fabric described are comparable with those of a braided hose.

| | | Abrasion | | |
|---|---|---|---|---|
| | | 5 mm mandrel, | | |
| | Flexural | 7 N, 0.45 mm | LV312 | Basis |
| | stiffness | wire | abrasion | weight |
| | in N | strokes | class | g/m² |
| Braided hose | 2.072 | 19100 | F | 400 |
| Nylon fabric | 0.046 | 18200 | F | 210 |

For the determination of the flexural rigidity, a specimen with dimensions of 75×60 mm is cut from the sample and clamped in a rotatable mount with an area of 50×60 mm. The mount is tipped so that the protruding part of the sample, with a length of 25 mm, is bent by 30°. The force exerted by the sample in the bent condition is detected by a force sensor. This force represents the measure of the flexural rigidity.

The measurement is made with an instrument from Wolf Messtechnik that can be calibrated.

As is evident, the tape with woven fabric backing achieves a mechanical strength with respect to abrasion like that exhibited by the known fabric hoses, without the need to accept the disadvantage of the increased rigidity.

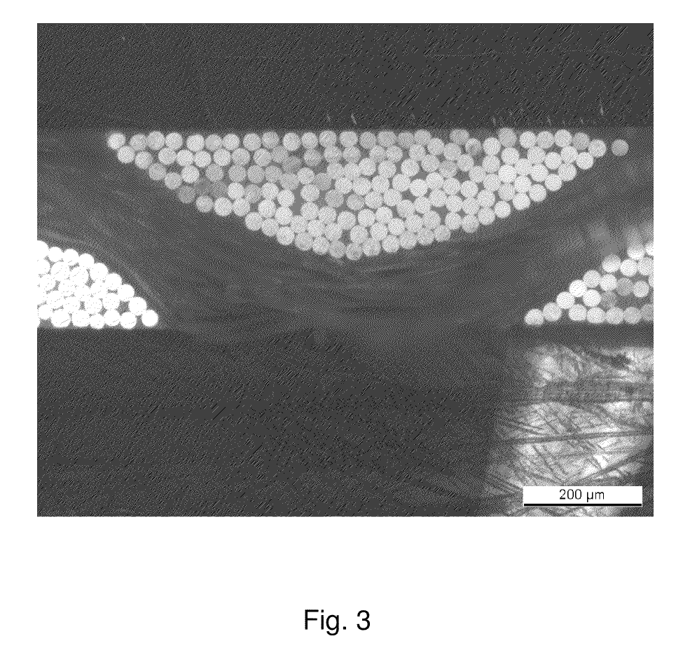

FIG. 3 shows a photograph of the tape of the invention in cross section. In the upper region, the photograph shows a single yarn composed of a large number of individual filaments.

The circular cross section of the filaments and the virtually ideally smooth outer casing make the filaments highly mobile when external mechanical pressure is exerted.

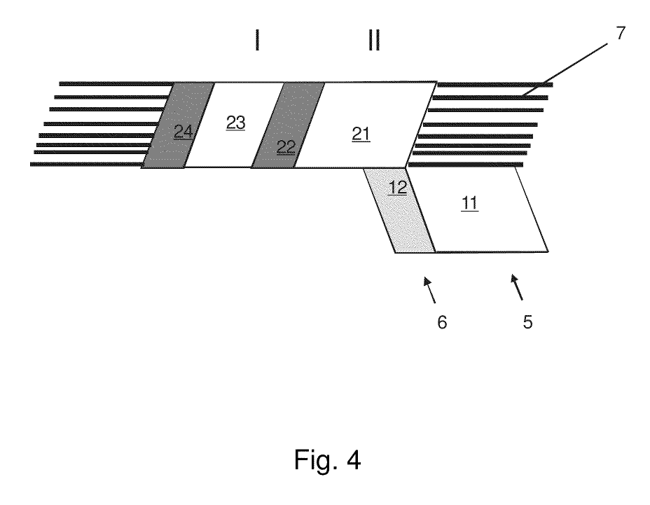

FIG. 4 shows a section of a cable loom which is composed of a bundle of individual cables 7 and which is wrapped with the adhesive tape of the invention. The adhesive tape is led in a helicoidal movement around the cable loom.

The section of cable loom shown has two turns I and II of the adhesive tape. To the left there would be further turns extending; they are not shown here.

Present on the adhesive coating 4 is a stripe 5 of the jacket, producing an adhesive stripe 6 which extends in the longitudinal direction of the tape. Non-adhesive regions 11, 21, 23 of the adhesive tape alternate with adhesive regions 12, 22, 24. (In contrast to the exposed adhesive 12, the sections 22, 24 are not visible from the outside, which is why the denser shading has been chosen to depict them).

The cable loom is wrapped in such a way that the stripe 6 of adhesive bonds fully to the adhesive tape. Bonding to the cables 7 is ruled out.

On account of the outstanding suitability of the tape, the tape of the invention can be used in a wrap which consists of a jacket, in which case, at least in one edge region of the jacket, there is a self-adhesive tape present that is bonded to the jacket in such a way that the adhesive tape extends over one of the long edges of the jacket, and, specifically, preferably in an edge region which is narrow in comparison to the width of the jacket.

The jacket is preferably formed by the fabric of the tape; in other embodiments, the fabric is used as a backing in the adhesive tape or in the adhesive tapes mentioned later on, or else both jacket and backing of the adhesive tape or tapes are composed of the tape of the invention.

In accordance with the preferred embodiment at least the jacket is composed of the tape of the invention.

The width of the jacket is advantageously selected so as largely to match the circumference of the material to be wrapped, in order as far as possible not to obtain a double ply of jacket over the material. The adhesive tape or tapes preferably have widths of between 10 and 25 mm.

If greater protection of the material or greater insulating properties are desired, the jacket may have a very much greater width than that corresponding to the circumference of the material to be wrapped, in order to obtain, for example, two-fold or three-fold wrapping of the material.

In a further advantageous embodiment of the invention the wrapping in the edge region of the jacket features a second self-adhesive tape, which is bonded to the jacket in such a way that the adhesive tape extends over the other of the two long edges of the jacket, and, specifically, preferably in an edge region which is narrow in comparison to the width of the jacket.

In a further advantageous embodiment of the invention the two adhesive tapes are arranged on the top face of the jacket.

It has emerged as being outstandingly suitable for one adhesive tape to be arranged on the top face of the jacket and for the other adhesive tape to be arranged on the underside of the jacket.

The wrapping, again, is intended advantageously for use for the wrapping of elongate material, such as cable harnesses more particularly, the elongate material being sheathed in the axial direction by the jacket. The sheathing of the material with the jacket is accomplished such that the self-adhesive tape bonds essentially to the jacket itself.

In a further advantageous embodiment the single-sidedly self-adhesive tape is bonded to the jacket in such a way that, relative to the centre axis of the material, the adhesive lies inwards.

In a further advantageous embodiment the single-sidedly self-adhesive tape is bonded to the jacket in such a way that, relative to the centre axis of the material, the adhesive lies outwards.

Furthermore, it has emerged as being advantageous if the single-sidedly self-adhesive tape is bonded to the first edge region of the jacket in such a way that, relative to the centre axis of the material, the adhesive lies inwards, and if a second self-adhesive tape is bonded to the second edge region of the jacket in such a way that, relative to the centre axis of the material, the adhesive lies outwards, the sheathing of the material taking place in such a way that the two adhesive tapes each bond to the jacket.

Likewise unexpectedly for the skilled person, many advantages arise if the single-sidedly self-adhesive tape is bonded to the first edge region of the jacket in such a way that, relative to the centre axis of the material, the adhesive lies inwards, and if a second self-adhesive tape is bonded to the second edge region of the jacket in such a way that, relative to the centre axis of the material, the adhesive lies inwards, the sheathing of the material being such that the first adhesive tape also bonds to the material, and the second adhesive tape bonds essentially to the jacket.

The first adhesive tape, which serves for easy fixing of the wrapping to the material, may have a narrower width than the second adhesive tape, which bonds the wrapping to the jacket.

Also having surprising advantages attached to it is a further form of a sheathing tape of this kind, in which the first adhesive tape is double-sidedly self-adhesive and therefore has active bonding areas both inwardly and outwardly. The second adhesive tape, which may also be a double-sidedly adhesive tape, is positioned on the second edge region of the jacket in such a way that, relative to the centre axis of the material, the adhesive tape lies inwards.

The material is sheathed in such a way that one side of the double-sidedly self-adhesive tape allows the sheathing tape to be fixed to the material, while the second side of the double-sidedly self-adhesive tape, along with the second adhesive tape, are available for bonding to the jacket or adhesive to adhesive.

For the embodiment equipped on one side with adhesive tape, the material can be sheathed in such a way that the adhesive of the adhesive tape
is bonded only to the jacket,
is bonded in each case partly to the jacket and partly to the material or
is bonded in each case partly to the jacket and in part is initially left open, in order subsequently to produce fixing, to metal bodywork panels, for example.

For the embodiment equipped on both sides with single-sidedly self-adhesive tape, the material may be sheathed in such a way that the adhesives of the two adhesive tapes
each bond partly to the jacket and partly to themselves
bond only to the jacket.

For the embodiment equipped with adhesive tape at both edges, at least one adhesive tape having a double-sided self-adhesive coating, the material can be sheathed in such a way that the adhesives which are not used for bonding directly to the material
in each case bond only to the jacket
in each case bond partly to the jacket and partly to themselves.

The bonding of the adhesive tape or tapes takes place preferably in such a way that there is a 50% overlap of the adhesive tape with the jacket.

As jacket and/or as backing material for the adhesive tape or tapes it is possible otherwise to use all known textile backings such as a loop product, a velour, a scrim, a woven fabric, a formed-loop knit, in particular a woven PET filament fabric or a woven nylon fabric, with the term “nonwoven web” meaning at least sheetlike textile structures in accordance with EN 29092 (1988) and also stitchbonded nonwovens and similar systems. Jacket and backing material need not necessarily consist of the same materials.

It is likewise possible to use spacer fabrics, including wovens and knits, with lamination. Spacer fabrics are mat-like layer structures comprising a cover layer of a fibre or filament fleece, an underlayer and individual retaining fibres or bundles of such fibres between these layers, the said fibres being distributed over the area of the layer structure, being needled through the particle layer, and joining the cover layer and the underlayer to one another. The retaining fibres needled through the particle layer hold the cover layer and the underlayer at a distance from one another and are joined to the cover layer and the underlayer.

Suitable nonwovens include, in particular, consolidated staple fibre webs, but also filament webs, meltblown webs and spunbonded webs, which generally require additional consolidation. Known consolidation methods possible for webs are mechanical, thermal and chemical consolidation. Whereas with mechanical consolidations the fibres are mostly held together purely mechanically by entanglement of the individual fibres, by the interlooping of fibre bundles or by the stitching-in of additional threads, it is possible by thermal and by chemical techniques to obtain adhesive (with binder) or cohesive (binder-less) fibre-fibre bonds. Given appropriate formulation and an appropriate process regime, these bonds may be restricted exclusively, or at least predominantly, to the fibre nodal points, thus forming a stable, three-dimensional network while retaining the loose, open structure in the web.

Webs which have proved to be particularly advantageous are those consolidated in particular by overstitching with separate threads or by interlooping.

Consolidated webs of this kind are produced, for example, on stitchbonding machines of the “Malifleece”, from the company Karl Mayer, formerly Malimo, and can be obtained from companies including Techtex GmbH. A Malifleece is characterized in that a cross-laid web is consolidated by the formation of loops from fibres of the web.

The jacket used may also be a web of the Kunit or Multiknit type. A Kunit web is characterized in that it originates from the processing of a longitudinally oriented fibre web to form a sheetlike structure which has loops on one side and, on the other, loop feet or pile fibre folds, but possesses neither threads nor prefabricated sheetlike structures. A web of this kind has also been produced, for example, for a relatively long time on stitchbonding machines of the “Kunitvlies” type from the company Karl Mayer. A further characterizing feature of this web is that, as a longitudinal-fibre web, it is able to absorb high tensile forces in the longitudinal direction. The characteristic feature of a Multiknit web relative to the Kunit web is that the web is consolidated on both the top and bottom sides by virtue of the double-sided needle punching.

Finally, stitchbonded webs are also suitable. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

And then the Caliweb® is outstandingly suitable. The Caliweb® consists of a thermally fixed Multiknit spacer web with two outer mesh layers and an inner pile layer, arranged perpendicular to the mesh layers.

Also particularly advantageous is a staple fibre web which is mechanically preconsolidated in the first step or is a wet-laid web laid hydrodynamically, in which between 2% and 50% of the fibres of the web are fusible fibres, in particular between 5% and 40% of the fibres of the web.

A web of this kind is characterized in that the fibres are laid wet or, for example, a staple fibre web is preconsolidated by the formation of loops from fibres of the web or by needling, stitching or air-jet and/or water-jet treatment.

In a second step, thermofixing takes place, with the strength of the web being increased again by the melting or partial melting of the fusible fibres.

The web backing may also be consolidated without binders, by means, for example, of hot embossing with structured rollers, in which case pressure, temperature, dwell time and the embossing geometry can be used to control properties such as strength, thickness, density, flexibility and the like.

Starting materials envisaged for the textile materials include, in particular, polyester, polypropylene, viscose or cotton fibres. The present invention is not, however, confined to the materials specified; rather it is possible to use a large number of other fibres to produce the web, this being evident to the skilled person without any need for inventive activity. Used in particular are wear-resistant polymers such as polyesters, polyolefins, polyamides or fibres of glass or of carbon.

Further suitable materials are laminates formed from films or from foams in sheet form (made of polyethylene and polyurethane, for example).

Also suitable for wrapping the elongate material is a jacket composed of paper, of a laminate, of a film (based, for example, on polyolefins (for example polyethylene, polypropylene or monoaxially or biaxially oriented polypropylene films, polyester films, polyamide films and other films) or PVC), of foam or of a foamed film.

The stated materials can also be used advantageously as backing material for the adhesive tape.

These non-textile sheetlike materials are particularly appropriate when specific requirements necessitate such a modification of the invention. Films are generally thinner in comparison to textiles, for example, and, as a result of the imperforate layer, offer additional protection against penetration of chemicals and service fluids such as oil, petrol, antifreeze and the like into the actual cable area, and can be substantially adapted to requirements by an appropriate selection of the material from which they are constructed: with polyurethanes and polyolefin copolymers, for example, flexible and elastic wraps can be produced; with polyester and nylons, high abrasion resistance and temperature resistance are achieved.

Foams or foamed films, on the other hand, possess the qualities of more substantial space filling and of good soundproofing—where a length of cable is laid, for example, in a duct- or tunnel-like area in the vehicle, a wrapping tape of appropriate thickness and soundproofing can prevent disruptive flapping and vibration from the outset.

For use in the case of cable looms which are used in automotive engineering, widths of 80, 105 and 135 mm are particularly advantageous for the jacket, but may also be produced variably according to the particular application; the length is guided by the design of the cable loom.

The overall product of the invention, comprising adhesive tape and jacket, in other words all embodiments of the wrap, may be provided in fixed lengths, such as by the metre, for example, or else as a continuous product on rolls (archimedean spirals). For use, then, in the latter case it is possible to separate off variable lengths by means of knives, shears or dispensers or the like, or else, given an appropriate choice of the materials both for the jacket and for the adhesive tapes, to carry out manual processing without tools.

For bonding, use is made in particular of strips of the adhesive tape which have a width of 15 to 50 mm.

As already described at length above for the adhesive tape, the wrap as well may be perforated.

The wrapping of the preferred cable loom provides it with outstanding protection and vibration damping. The textile jacket is lightweight, and so very little weight is added to the cable loom, and is stretchable, and so the cable loom overall is deformable. In difficult situations, accordingly, it can be adapted outstandingly to the available space conditions. As a result of its originally circular or oval cross section, the cable loom of the invention makes it easier to pass the cables without disruption through bores, holes, apertures and the like, and then allows it to be readily deformed into other geometries and cross sections, so that it can be adapted ideally to the local circumstances. Thus it is even possible to obtain a virtually flat profile when laying cables under the carpet, in the floor assembly, for example, without having to incorporate the different cross sections during actual manufacture of the cable loom.

It also proves to be advantageous that, in the region of the initial bonding, there can be up to three plies of backing atop one another; where particularly high requirements are imposed on the insulation properties or the abrasion resistance, and are confined to sub-regions of the cross section, the point of overlap can be positioned in accordance with the requirements; the area of the multi-ply section can easily be controlled through the selection of the width of the adhesive tape, and also via the bonding technique.

Finally, the inventive type of wrapping prevents creasing.

Further advantages of the solution described are that it comprises a tidy, flagging-free cable loom which possesses good surface protection and ensures high bundling power, effective noise suppression and, in the case of thick cable harnesses, a very high level of deformability in the cross-sectional direction.

The wrap is illustrated below with reference to a number of figures, without thereby wishing to impose restriction of any kind at all.

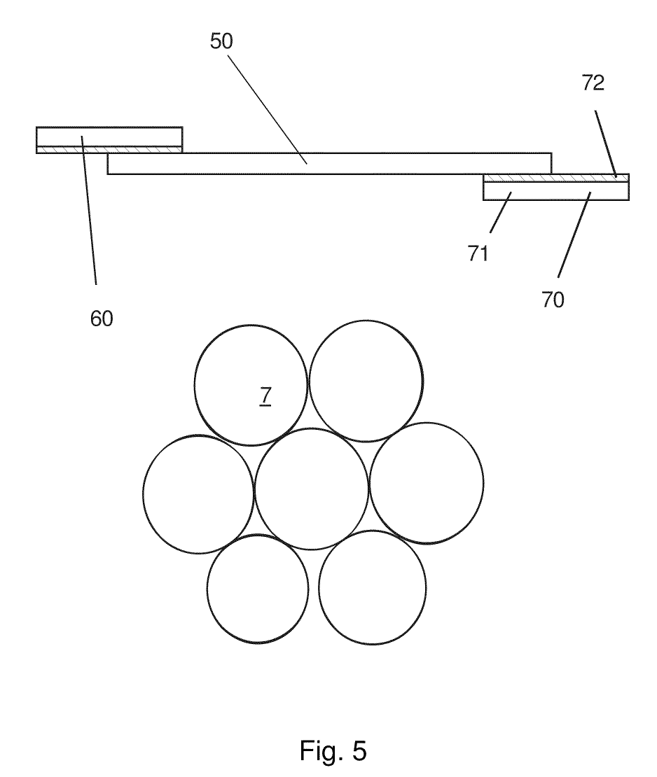

FIG. 5 shows in cross section a wrap with a textile jacket 50 which can be used to wrap elongate material, especially cable harnesses.

A single-sidedly self-adhesive tape 60 is bonded in the axial direction of the material to at least one edge region of the jacket 50, the said edge region being narrow in comparison to the width of the jacket 50, in such a way that, relative to the centre axis of the material (cable loom 7) to be wrapped, the adhesive is on the inside. Bonded on the second edge region of the jacket 50 is a second self-adhesive tape 70, bonded in such a way that, relative to the centre axis of the material, the adhesive 72 is on the outside. The adhesive tape 70 is composed substantially of the preferably textile backing 71 and the adhesive 72.

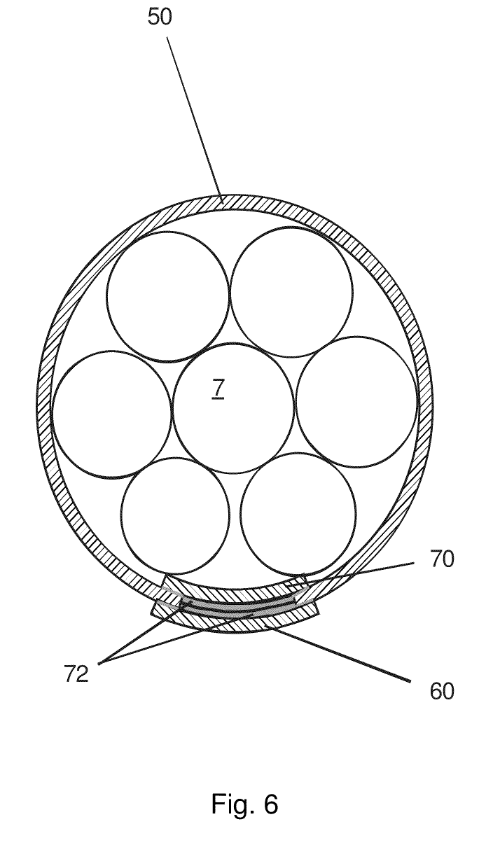

FIG. 6 shows a sheathed cable loom 7 composed of individual cables, in this case seven. The cable loom 7 is wrapped in such a way that the adhesives 72 of the two adhesive tapes 60 and 70 each bond to the jacket 50 and in part to themselves; in the case depicted, the bonding of the adhesive tape on the jacket is less than 50%.

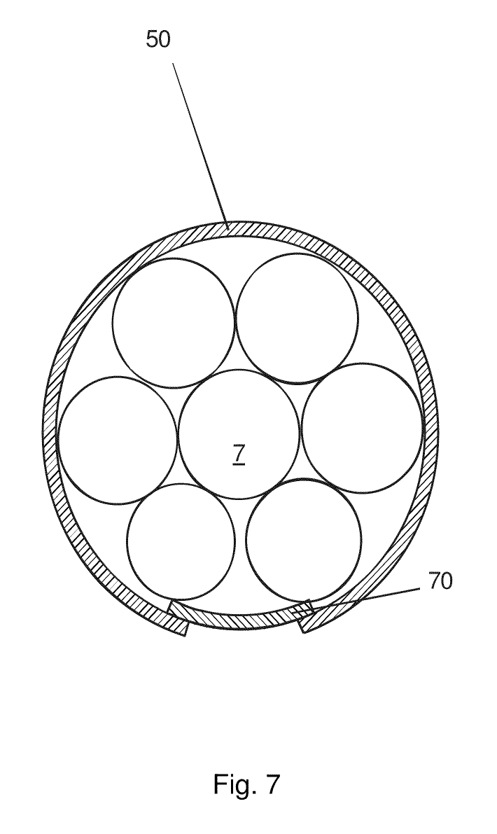

By omitting the adhesive tape 60, as shown in FIG. 7, a further embodiment, as a result of an outwardly oriented adhesive stripe, lies in the possibility of fixing the longitudinally wrapped cable loom to surrounding surfaces, for example to metal bodywork panels, in order thus to prevent slipping, flapping or the like.

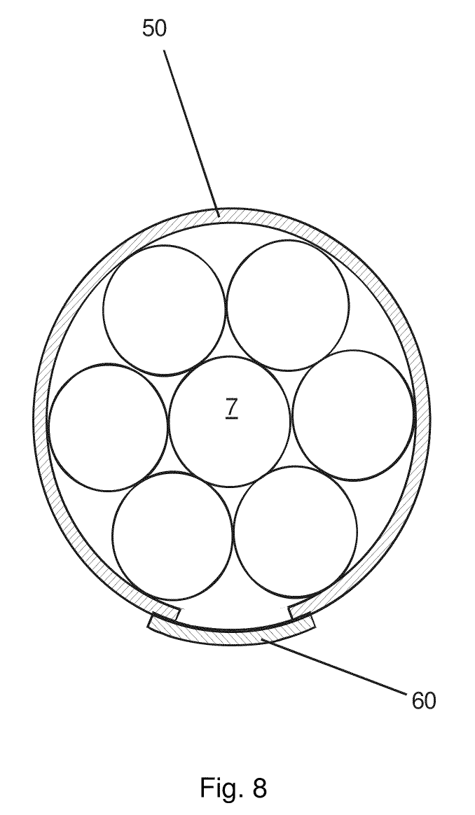

In another, separate embodiment, it is possible, by omission of the adhesive tape 70 (see FIG. 8)—that is, only one edge of the jacket is provided with an adhesive tape—to retain a narrow adhesive region of the adhesive tape, directed inwards relative to the cable loom, with this region bonding firmly to one or more individual cables of the cable loom and thus fixing the configuration. This largely prevents the wrap slipping.

In FIGS. 7 and 8 the layer of adhesive present on the backing material is not illustrated in so distinct a way as in FIG. 6.

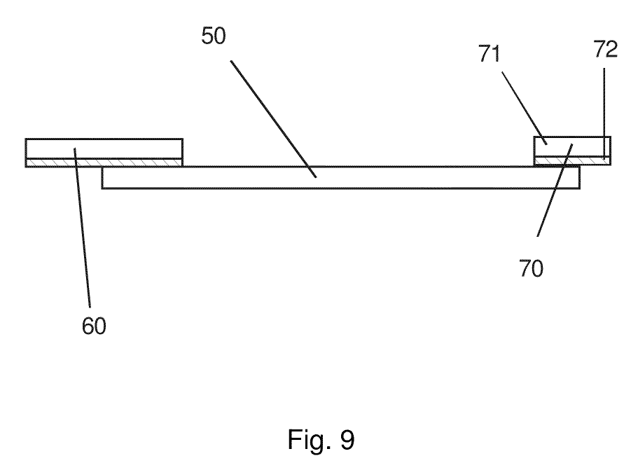

FIG. 9 shows in cross section a second wrap with a textile jacket 50 that can be used to wrap elongate material, especially cable harnesses.

A single-sidedly self-adhesive tape 60 is bonded in the axial direction of the material to at least one edge region of the jacket 50, the said edge region being narrow in comparison to the width of the jacket 50, in such a way that, relative to the centre axis of the material to be wrapped (cable loom 7), the adhesive is on the inside. Bonded on the second edge region of the jacket 50 is a second self-adhesive tape 70, bonded in such a way that, relative to the centre axis of the material, the adhesive 72 is likewise on the inside.

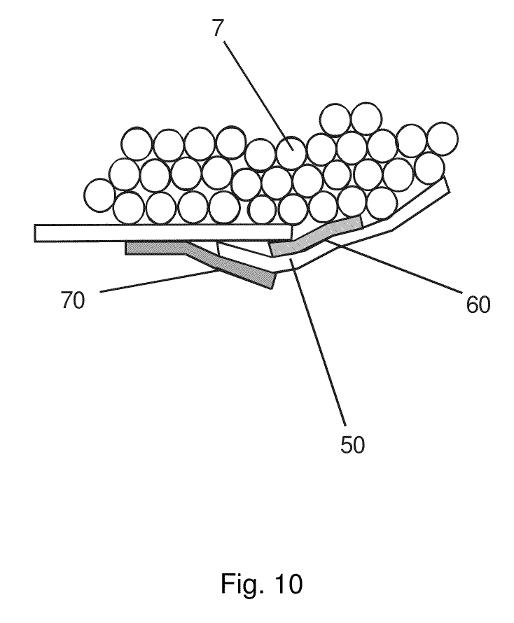

FIG. 10 shows the material 7 wrapped with the wrap from FIG. 5, especially the region which fixes the sheath in its position.

During the wrapping procedure, the first adhesive tape 60 serves to affix the jacket 50 or the entire wrap easily on the material 7, so that the wrap does not slip. The first adhesive tape 60 is narrower than the second adhesive tape 70 which fixes the jacket 50 and thus the entire wrap around the material 7.

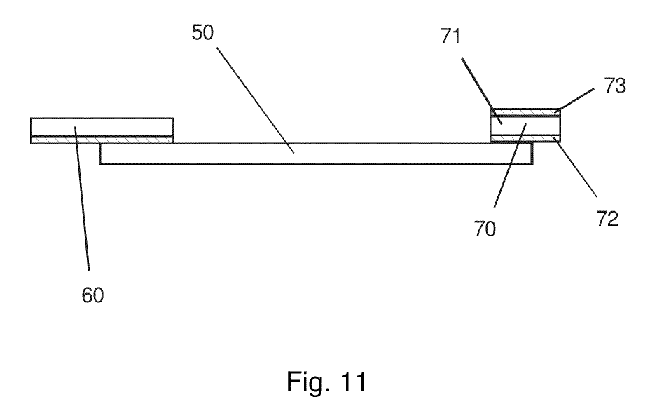

FIG. 11 shows in cross section a further wrap with a textile jacket 50 that can be used to wrap elongate material, especially cable harnesses.

The wrap corresponds essentially to that from FIG. 9, but on the second edge region of the jacket 50 there is a second self-adhesive tape 70, which is double-sidedly self-adhesive, in other words having two layers 72 and 73 of adhesive.

Otherwise the adhesive tape 70 is composed essentially of the preferably textile backing 71.

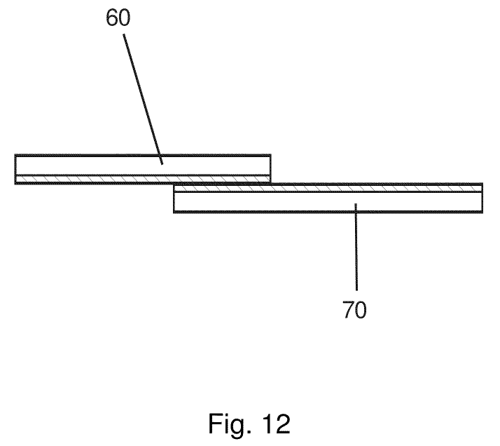

In a further embodiment for a wrap, two inventive tapes 60 and 70, equipped with an adhesive, are laminated to one another with their adhesives offset (preferably by 50% in each case), producing a product as shown in FIG. 12.

This embodiment as well finds application as described above for the wrap.

Also embraced by the concept of the invention, finally, is an elongate material such as, more particularly, a cable harness, wrapped with the tape of the invention or the above-described wraps, and also a vehicle comprising an inventively wrapped cable loom.

The general expression “adhesive tape” for the purposes of this invention encompasses all sheetlike structures such as two-dimensionally extended films or film sections, tapes with extended length and limited width, tape sections, diecuts, labels and the like.

The invention is illustrated below with reference to a number of examples, without thereby wishing to confine the invention in any way.

### EXAMPLES

### Example 1

### Inventive

The weaving of nylon 6,6 yarns from INVISTA with a linear density of 1100 dtex and 140 filaments per yarn in plain-weave construction with a set of 13 threads/cm warp and 12 threads/cm weft leads to a basis weight of 280 g/m². The fabric obtained exhibits an ultimate tensile strength of 680 N/cm with an elongation at break of 36% and has a flexural rigidity of 0.044 N. Coating with an acrylate adhesive at 120 g/m² leads to an adhesive tape which on a 5-mm and a 10-mm mandrel exhibits an LV312 abrasion class F.

| | |
|---|---|
| ISO 6722 abrasion 7 N/5-mm mandrel | 18800 strokes |
| ISO 6722 abrasion 7 N/10-mm mandrel | 31200 strokes |

### Example 2

### Inventive

Nylon 6,6 yarns with a linear density of 470 dtex and 144 filaments per yarn in plain-weave construction with a set of 20 threads/cm warp and 20 threads/cm weft lead to a basis weight of 210 g/m². The fabric produced exhibits a flexural rigidity of 0.046 N, an ultimate tensile strength of 650 N/cm and an elongation at break of 47%. Coating with an acrylate adhesive at 100 g/m² leads to an adhesive tape which on a 5-mm and a 10-mm mandrel exhibits an LV312 abrasion class F.

| | |
|---|---|
| ISO 6722 abrasion 7 N/5-mm mandrel | 18200 strokes |
| ISO 6722 abrasion 7 N/10-mm mandrel | 28000 strokes |

### Example 3

### Inventive

The weaving of nylon 6 yarns with a linear density of 470 dtex and 136 filaments per yarn in plain-weave construction with a set of 21 threads/cm warp and 15 threads/cm weft leads to a basis weight of 190 g/m². The fabric exhibits a flexural rigidity of 0.029 N. Coating with an acrylate adhesive at 100 g/m² leads to an adhesive tape which on a 5-mm and a 10-mm mandrel exhibits an LV312 abrasion class E.

| | |
|---|---|
| ISO 6722 abrasion 7 N/5-mm mandrel | 6600 strokes |
| ISO 6722 abrasion 7 N/10-mm mandrel | 12100 strokes |

### Example 4

### Comparative

Comparison with Inventive Example 2 shows a significantly lower abrasion resistance with a reduced number of filaments in the yarn. The weaving of nylon 6,6 yarns with a linear density of 470 dtex and 68 filaments per yarn in plain-weave construction with a set of 20 threads/cm warp and 14 threads/cm weft leads to a basis weight of 185 g/m². The fabric exhibits a flexural rigidity of 0.021 N. Coating with an acrylate adhesive at 100 g/m² leads to an adhesive tape which on a 5-mm mandrel exhibits an LV312 abrasion class D and on a 10-mm mandrel exhibits an LV312 abrasion class E.

| | |
|---|---|
| ISO 6722 abrasion 7 N/5-mm mandrel | 3700 strokes |
| ISO 6722 abrasion 7 N/10-mm mandrel | 5900 strokes |

### Example 5

### Comparative

Comparison with inventive Example 2 shows a significantly lower abrasion resistance when polyester is used as the plastics material of the yarn. The weaving of polyester yarns with a linear density of 370 dtex and 102 filaments per yarn in plain-weave construction with a set of 27 threads/cm warp and 22 threads/cm weft leads to a basis weight of 180 g/m². The fabric exhibits a flexural rigidity of 0.029 N. Coating with an acrylate adhesive at 100 g/m² leads to an adhesive tape which on a 5-mm and a 10-mm mandrel exhibits an LV312 abrasion class D.

| | |
|---|---|
| ISO 6722 abrasion 7 N/5-mm mandrel | 1300 strokes |
| ISO 6722 abrasion 7 N/10-mm mandrel | 2200 strokes |

1. Highly abrasion-resistant tape for sheathing elongate material, comprising a woven fabric backing, comprised of yarns of a plastics material, the yarns having a linear density of 280 to 1100 dtex, and each yarn being constructed from at least 90 single filaments.

2. Tape according to claim 1, wherein the yarns are constructed from 90 to 288 single filaments.

3. Tape according to claim 1, wherein the woven fabric backing comprises a number of warp threads in the 12 to 45 per cm range.

4. Tape according to claim 1, wherein the woven fabric backing comprises a number of weft threads in the 10 to 35 per cm range.

5. Tape according to claim 1, wherein the woven fabric backing has a basis weight of 130 to 300 g/m².

6. Tape according to claim 1, wherein the yarns of the plastics material of the woven fabric are nylon 6, nylon 6,6, nylon 6,6 heat-stabilized, polyether ketones (PEEK) or polyphenylene sulphides (PPS).

7. Tape according to claim 1, wherein the tape exhibits an ultimate tensile strength of more than 500 N/cm and/or an elongation at break between 35% and 65%.

8. Tape according to claim 1, which comprises at least one adhesive coating, wherein the adhesive coating is a self-adhesive coating, based on rubber, acrylate or silicone.

9. A method for wrapping elongate material, said method comprising sheathing the elongate material in an axial direction by a tape, or leading the tape in a helicoidal spiral around the elongate material, wherein the tape is a tape according to claim 1.

10. A method of preparing a wrapping composed of a jacket, comprising providing a self-adhesive tape on at least one edge region of the jacket, and bonding the self-adhesive tape to the jacket in such a way that the adhesive tape extends over one of the long edges of the jacket, the jacket or the backing of the adhesive tape, or jacket and backing of the adhesive tape, being formed by the tape, wherein the tape is a tape according to claim 1.

11. A method for wrapping, comprising laminating two adhesive tapes by their adhesives to one another, optionally with an offset each of 50%, wherein each of the two adhesive tapes is a tape according to claim 1.

12. Elongate material wrapped with a tape according to claim 1.

13. Vehicle comprising an elongate material according to claim 12.
